(19) United States
(12) Patent Application Publication
(10) Pub. No.: US 2012/0175276 A1
(43) Pub. Date: Jul. 12, 2012

(54) HEADSPACE SEALING AND DISPLACEMENT METHOD FOR REMOVAL OF VACUUM PRESSURE

(76) Inventor: David Murray Melrose, Auckland (NZ)

(21) Appl. No.: 13/195,867

(22) Filed: Aug. 2, 2011

Related U.S. Application Data
(63) Continuation of application No. 12/639,903, filed on Dec. 16, 2009, now abandoned.
Application No. 12/639,903 is a continuation of application No. 10/598,544, filed on Oct. 17, 2006, now abandoned.

(30) Foreign Application Priority Data
Mar. 4, 2004 (NZ) 531573
Jan. 18, 2005 (NZ) 537746

(51) Int. Cl. B65D 53/00; B65B 63/08; B67C 3/02; B65D 41/62; B65D 1/04

(52) U.S. Cl. 206/223; 215/200; 215/6; 215/307; 53/440

(57) ABSTRACT

A container (1) is intended for filling with a hot liquid (21). The container (1) has a neck finish (2) with an opening closed off by a primary seal (4) which has an expandable side wall (4a). As the liquid (21) cools, the side wall (4a) is drawn into the container (1) to remove vacuum pressure created within the container (1). A permanent cap (25) can provide a secondary seal for the container and define a secondary headspace (24b) between the primary and secondary seals (4) (25). In other embodiments the seal (4) can be replaced by a mechanically movable seal which may be locked in its downward position. Also the secondary seal can be provided with a port or aperture to provide access into the secondary headspace for a commodity. Also a commodity such as a tablet or pill may be provided within the secondary headspace.

### TECHNICAL FIELD OF THE INVENTION

This invention relates generally to a method of light-weighting hot fill containers by utilising a container sealing structure that provides for the removal of vacuum pressure. This is achieved by filling a container with a heated fluid, liquid will now be referred to, sealing the neck finish of the container with a moveable sealing structure during the hot fill process. The sealing structure is then displaced inwardly to negate vacuum forces generated within the container following liquid cooling. The sealing structure thereby displaces the liquid below the headspace in the upper neck region of the container downwardly prior to finally capping and labelling the container. This invention further relates to hot-filled and pasteurized products packaged in heat-set polyester containers and is particularly useful for packaging oxygen sensitive foods and beverages where a longer shelf life is desirable.

### BACKGROUND

So called ‘hot fill’ containers are well known in prior art, whereby manufacturers supply PET containers for various liquids which are filled into the containers and the liquid product is at an elevated temperature, typically at or around 85 degrees C. (185 degrees F.).

The container is manufactured to withstand the thermal shock of holding a heated liquid, resulting in a ‘heat-set’ plastic container. This thermal shock is a result of either introducing the liquid hot at filling, or heating the liquid after it is introduced into the container.

Once the liquid cools down in a capped container, however, the volume of the liquid in the container reduces, creating a vacuum within the container. This liquid shrinkage results in vacuum pressures that pull inwardly on the side and end walls of the container. This in turn leads to deformation in the walls of plastic bottles if they are not constructed rigidly enough to resist such force.

Typically, vacuum pressures have been accommodated by the use of vacuum panels, which distort inwardly under vacuum pressure. Prior art reveals many vertically oriented vacuum panels that allow containers to withstand the rigors of a hot fill procedure. Such vertically oriented vacuum panels generally lie parallel to the longitudinal axis of a container and flex inwardly under vacuum pressure toward this longitudinal axis.

In addition to the vertically oriented vacuum panels, many prior art containers also have flexible base regions to provide additional vacuum compensation. Many prior art containers designed for hot-filling have various modifications to their end-walls, or base regions to allow for as much inward flexure as possible to accommodate at least some of the vacuum pressure generated within the container.

Even with such substantial displacement of vacuum panels, however, the container requires further strengthening to prevent distortion under the vacuum force.

The liquid shrinkage derived from liquid cooling, causes a build up of vacuum pressure. Vacuum panels deflect toward this negative pressure, to a degree lessening the vacuum force, by effectively creating a smaller container to better accommodate the smaller volume of contents. However, this smaller shape is held in place by the generating vacuum force. The more difficult the structure is to deflect inwardly, the more vacuum force will be generated. In prior art proposals, a substantial amount of vacuum may still be present in the container and this tends to distort the overall shape unless a large, annular strengthening ring is provided in horizontal, or transverse, orientation typically at least a ⅓ of the distance from an end to the container.

The present invention relates to hot-fill containers and may be used in conjunction with the hot fill containers described in international applications published under numbers WO 02/18213 and WO 2004/028910 (PCT specifications) which specifications are also incorporated herein in their entirety where appropriate.

The PCT specifications background the design of hot-fill containers and the problems with such designs that were to be overcome or at least ameliorated.

A problem exists when locating such transversely oriented panels in the container side-wall, or end-wall or base region, even after vacuum is removed completely from the container when the liquid cools down and the panel is inverted. The container exits the filling line just above a typical ambient temperature, and the panel is inverted to achieve an ambient pressure within the container, as opposed to negative pressure as found in prior art. The container is labelled and often refrigerated at point of sale.

This refrigeration provides further product contraction and in containers with very little sidewall structure, so-called ‘glass look-a-like’ bottles, there may therefore be some paneling that occurs on the containers that is unsightly. To overcome this, an attempt is made to provide the base transverse panel with more extraction potential than is required, so that it may be forced into inversion against the force of the small headspace present during filling. This creates a small positive pressure at fill time, and this positive pressure provides some relief to the situation. As further cool down occurs, for example during refrigeration, the positive pressure may drop and may provide for an ambient pressure at refrigerated temperatures, and so avoid paneling in the container.

This situation is very hard to engineer successfully, however, as it depends on utilising a larger headspace in order to compress at base inversion time, and it is less desirable to introduce a larger headspace to the container than is necessary in order to retain product quality.

While it is desirable to have the liquid level in the container drop, to avoid spill when opened by the consumer, it has been found that providing too much positive pressure potential within the base may cause some product spill when the container is opened, particularly if at ambient temperatures.

In most filling operations, containers are generally filled to a level just below the container's highest level, at the top of the neck finish.

Maintaining as small a container headspace as possible is desirable in order to provide a tolerance for subtle differences in product density or container capacity, to minimize waste from spillage and overflow of liquids on a high-speed package filling line, and to reduce container contraction from cooling contents after hot fill.

Headspace contains gases that in time can damage some products or place extra demands on container structural integrity. Examples include products sensitive to oxygen and products filled and sealed at elevated temperatures.

Filling and sealing a rigid container at elevated temperatures can create significant vacuum forces when excessive headspace gas is also present.

Accordingly, less headspace gas is desirable with containers filled at elevated temperatures, to reduce vacuum forces acting on the container that could compromise structural integrity, induce container stresses, or significantly distort container shape. This is also true during pasteurization and retort processes, which involve filling the container first, sealing, and then subjecting the package to elevated temperatures for a sustained period.

Those skilled in the art are aware of several container manufacturing heat-set processes for improving package heat-resistant performance. In the case of the polyester, polyethylene terephthalate, for example, the heat-setting process generally involves relieving stresses created in the container during its manufacture and to improve crystalline structure.

Typically, a polyethylene terephthalate container intended for a cold-fill carbonated beverage has higher internal stresses and less crystalline molecular structure than a container intended for a hot-fill, pasteurized, or retort product application. However, even with containers such as described in the abovementioned PCT specifications where there is little residual vacuum pressure, the neck finish of the container is still required to be very thick in order to withstand the temperature of fill.

Where reference in this specification is made to any prior art this is not an acknowledgment that it forms part of the common general knowledge in any country or region.

### OBJECTS OF THE INVENTION

In view of the above, it is an object of one possible embodiment of the present invention to provide a headspace sealing and displacement method that can provide for removal of vacuum pressure such that there is substantially no remaining force within the container.

It is a further object of one possible embodiment of the present invention to provide a headspace displacement method whereby a moveable seal is applied to the neck finish of the container.

It is a further object of one possible embodiment of the present invention to provide a headspace displacement method whereby a moveable seal is applied to the neck finish that is forcibly displaceable into the container, such that a positive pressure may be induced into the container.

It is a further object of one possible embodiment of the present invention to provide a headspace displacement method whereby a moveable seal is applied to the neck finish that is moveable into the container under the effect of vacuum pressure alone.

It is a further object of one possible embodiment of the present invention to provide a headspace displacement method whereby a seal is applied to the neck finish that provides a protected pocket within the capped neck finish for additional commodities to be placed.

A further and alternative object of the present invention in all its embodiments, all the objects to be read disjunctively, is to at least provide the public with a useful choice.

### SUMMARY OF THE INVENTION

According to one aspect of the present invention there is provided a container having an upper portion with an opening into said container, said upper portion having a neck finish adapted to include a moveable seal following the introduction of a heated or heatable liquid into the container, said seal being capable of movement within the neck finish to compensate for vacuum forces during cooling of the liquid.

According to a further aspect of the invention in a container as immediately above defined in which said seal is of a flexible material having an expandable side wall.

According to a still further aspect of the invention, in a container as defined in two paragraphs above, said seal is physically moveable relative to the neck finish and towards the liquid in the container.

Preferably a secondary seal may provide a secondary headspace with said seal.

Possibly a commodity may be provided into, or positioned in, said secondary headspace.

According to a further aspect of the invention a method of filling a container with a fluid includes introducing the fluid through an open end of the container so that it, at least substantially, fills the container, heating the fluid before or after its introduction into the container, heating the fluid before or after its introduction into the container, providing a moveable seal for the open end to cover and contain the fluid, said seal being capable of responding to the expansion or contraction of the fluid so as to compensate for pressure in a headspace of the container under the seal.

Further aspects of the invention which should be considered in all its novel aspects will become apparent from the following description.

### BRIEF DESCRIPTION OF DRAWINGS

FIG. 1a: shows a cross-sectional view of a prior art hot-fill container in its open condition and filled to just below the top of the neck finish;

FIG. 1b: shows the typical fluid level after liquid contraction from cooling in the to container of FIG. 1a;

FIG. 1c: shows a typical closure or cap sealing structure placed on the neck finish of the container of FIG. 1a;

FIG. 2a: shows the container of FIG. 1a immediately post-fill, and in accordance with one possible embodiment of the invention with an expandable seal applied to the top of the neck finish to secure the beverage and small headspace under the seal;

FIG. 2b: shows the container of FIG. 2a with a temporary cap applied during the cool down process to protect the seal from water spray damage;

FIG. 2c: shows the container of FIG. 2b post cool down and liquid contraction with the temporary cap removed.

FIG. 2d: shows the container of 2c with a permanent cap applied;

FIG. 3a-b: shows a container according to a further embodiment of the invention with a mechanically compressible cap applied to seal the beverage;

FIG. 3c-d: shows the container of FIG. 3a-b with the compressible cap in the compressed state to displace the headspace vacuum and provide positive pressure to the inside of the container post cooling;

FIGS. 4a-b: show an enlarged view of an example expandable seal according to one embodiment of the present invention in the collapsed form and in the expanded form

FIG. 5a-b: show an enlarged view of an example compressive cap according to one embodiment of the present invention in the uncompressed and compressed states;

FIG. 6a-d: show an example of another possible embodiment of the invention including locating an ingredient within the pocket contained between the primary seal and secondary sealing cap, and then removing the secondary sealing cap, removing the ingredient, removing the primary seal, and placing the ingredient into the beverage;

FIGS. 7a-7d: show an alternative embodiment of the secondary sealing cap shown in FIGS. 2a-d whereby a hole is included to allow ingress of air.

FIGS. 8a-d: show an alternative embodiment of the secondary sealing cap shown in FIGS. 7a-d whereby a commodity is introduced through the cap to benefit the contained product.

FIGS. 9a-e: show an alternative example of a secondary sealing cap whereby a large opening is provided in the central portion.

FIGS. 10a-f: show an alternative example of a primary seal whereby the material utilized is highly expandable and/or may be placed in the upwardly inclined or downwardly inclined position to seal the liquid;

FIGS. 11a-e: show an alternative embodiment of the method demonstrated in FIGS. 2 a-d whereby the secondary headspace is further compressed by inverting a transverse base panel

FIGS. 12a-g: show an alternative example of a primary sealing cap whereby the primary seal is downwardly forcible by mechanical means and locks in to place.

FIG. 13: are a pictorial schematic of a method according to one embodiment of the preset invention.

FIGS. 14a-14c: show enlarged views of examples of the primary and secondary seals of FIGS. 7b and c.

FIGS. 15a-b: show part cross-sectional views of an alternative embodiment of the compressed cap seal of FIGS. 3 and 5.

### DETAILED DESCRIPTION OF PREFERRED EMBODIMENTS

The following description of preferred embodiments is merely exemplary in nature, and is in no way intended to limit the invention or its application or uses.

As discussed above, to accommodate vacuum forces during cooling of the contents within a heat set container, containers have typically been provided with a series of vacuum panels around their sidewalls and an optimized base portion. The vacuum panels deform inwardly, and the base deforms upwardly, under the influence of the vacuum forces. This prevents unwanted distortion elsewhere in the container. However, the container is still subjected to internal vacuum force. The panels and base merely provide a suitably resistant structure against that force. The more resistant the structure the more vacuum force will be present. Additionally, end users can feel the vacuum panels when holding the containers.

Typically at a bottling plant the containers will be filled with a hot liquid and then capped before being subjected to a cold-water spray resulting in the formation of a vacuum within the container that the container structure needs to be able to cope with. The present invention relates to hot-fill containers and a method that provides for the substantial removal or substantial negation of vacuum pressure. This allows much greater design freedom and light weighting opportunity as there is no longer any requirement for the structure to be resistant to vacuum forces that would otherwise mechanically distort the container.

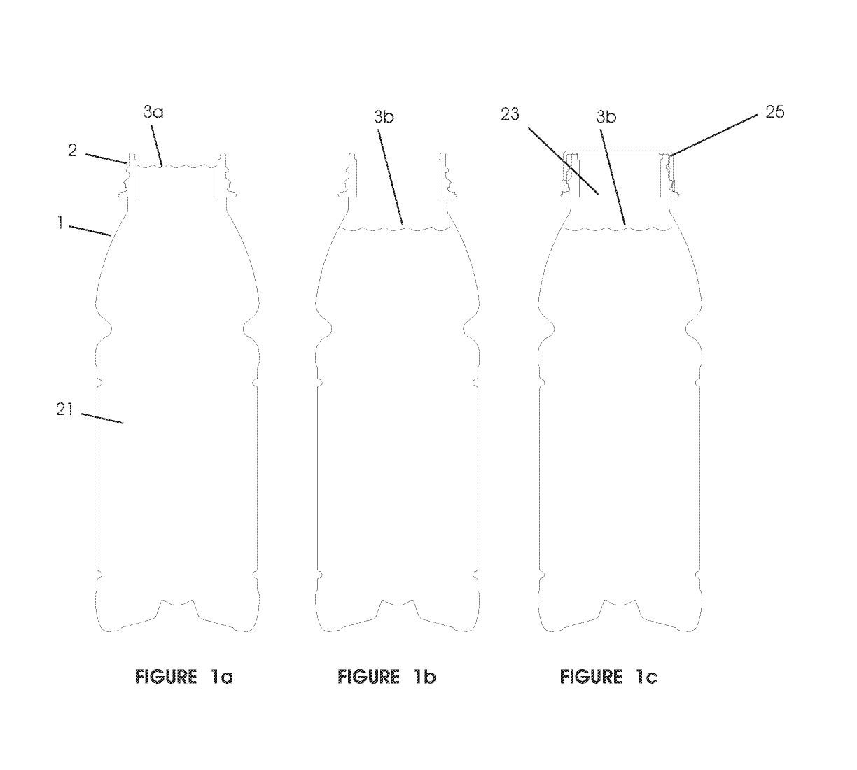

As seen in FIGS. 1a and b, when hot liquid (21) is introduced to a container (1), the liquid occupies a volume that is defined by a first upper level (3a). If left uncapped the liquid shrinks as it cools down and then occupies a volume that is defined by a second upper level (3b).

Should a cap (25) be applied immediately post fill, as seen in FIG. 1c, then a vacuum builds up in the primary headspace (23) that is above the liquid and under the primary sealing cap (25) and is only released when the cap is removed. While the primary seal above the liquid and primary headspace remains in place then the vacuum force remains largely unchanged. If the walls of the container bend or flex inwardly then the vacuum pressure level may drop to a small degree.

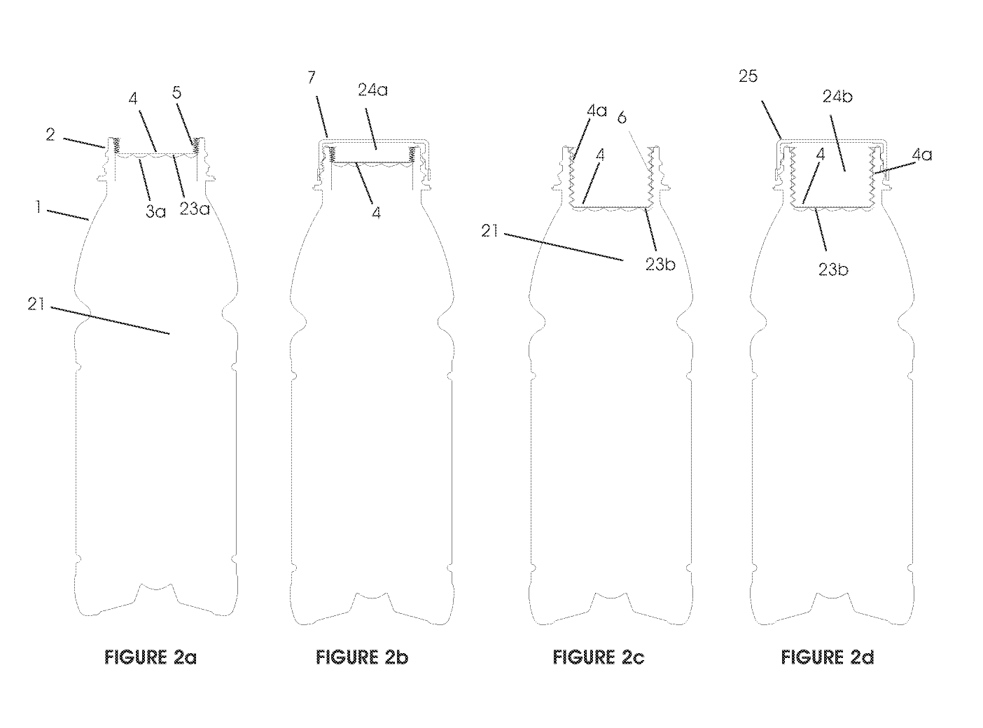

Referring to FIGS. 2a to d, one preferred form the current invention provides for a primary expandable seal (4) to be applied to the neck finish (2) of the container following the introduction of the hot liquid (21) to the container (1). Preferably the liquid is filled to as high a point as possible (3a), so that upon sealing there is a minimal headspace (23a) remaining in the container. The seal (4) provides integrity such that outside air may no longer interact with the liquid. The hot liquid within the container then sterilizes the underside of the primary seal, often as the container is turned upside down following sealing. Once sterilized it is paramount that the primary seal is not broken or removed, in order to prevent ingress of non-sterile outside air into the container and under the primary seal, otherwise product integrity would be compromised.

A secondary temporary sealing cap (7) is applied to cover the primary expandable seal (4). The secondary seal (7) provides protection from the water spray typically used to cool the container down prior to application of a label.

As the product cools, a vacuum will build up within the container in the primary headspace (23a) under the primary seal (4) and in the secondary headspace (24a) between the primary seal (4) and the secondary seal (7). This vacuum may distort the container (1) to a degree if the walls are not rigid enough to withstand the force.

Once the product is cooled the secondary seal (7) may be removed as shown in FIG. 2c. Immediately the increased pressure outside the container pushes the expandable primary seal (4) downwards and thereby the pressure within the container is equalised. The expandable side wall (4a) of the primary seal (4) moves from a shortened position (5) shown in FIG. 2a to a lengthened position (6) shown in FIG. 2c. The vacuum pressure is removed from the primary headspace (23b) as shown in FIG. 2c. Distortion is removed from the container and a permanent cap (25) may then be applied, as shown in FIG. 2d, and a label applied to the container. The expandable primary seal may be drawn in to full extension simply by the vacuum pressure alone once the temporary secondary sealing cap (7) has been removed. Once equilibrium has been established, and this is virtually immediate, the permanent secondary sealing cap, may simply be applied. It will be appreciated that the secondary seal (7) may be re-applied in the place of a permanent cap (25). Referring to FIG. 2d, through this method, not only is the vacuum pressure removed from the primary headspace (23b), but also from the secondary headspace (24b).

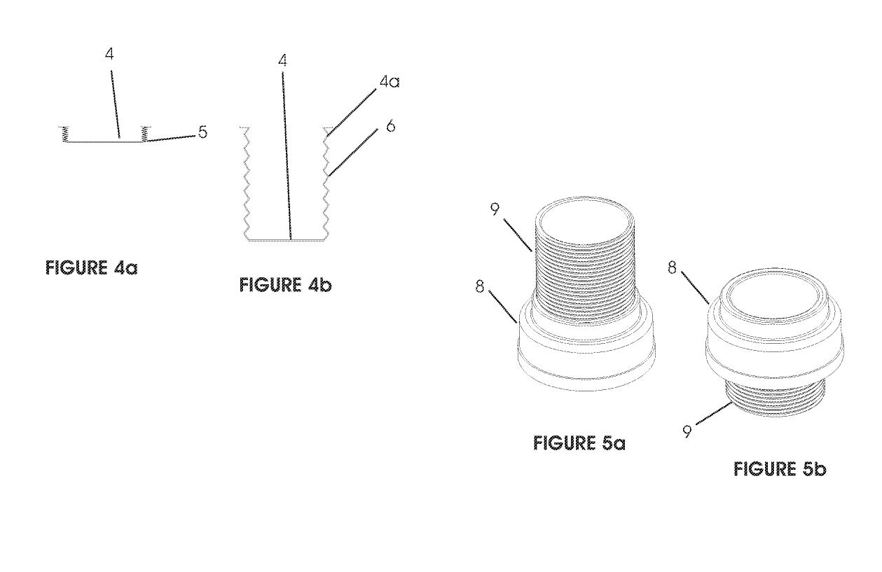

FIGS. 4a and 4b show the expandable seal (4) of FIG. 2 in separate detail.

The seal (4) may suitably be of a flexible plastics material having a rim portion (4a) which can engage with the rim of the neck finish (2) so that the seal (4) is held in place in its shortened and expanded positions. Also concertina-like side walls (4a) can provide the expansion of the seal (4) into the neck finish (2). Typically the secondary seal (7) and the permanent cap (25) may also be of plastics material.

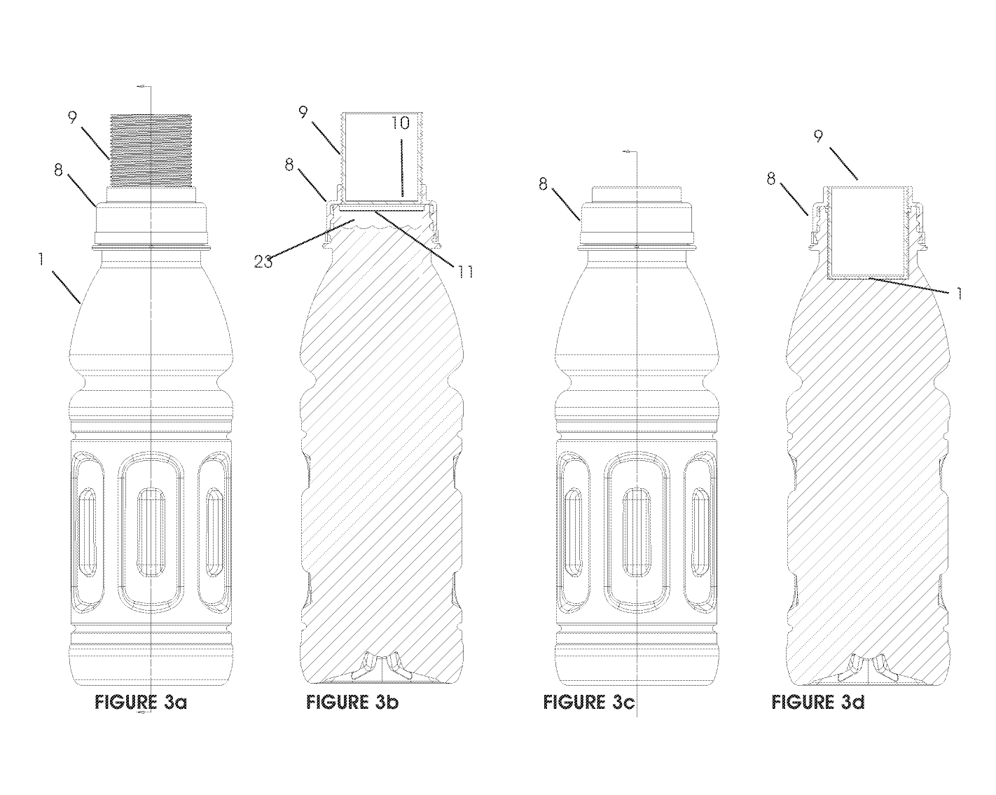

The primary seal could also be configured to be downwardly forcible, and could also be configured to avoid the need to be secured under a secondary seal. For example the primary seal could be applied in the form of a mechanical cap that has a mechanically controllable “out” and “in” position. Referring to FIGS. 3a and b, a compressive cap (8) is applied to the container (1) immediately post filling with a hot beverage. This provides for the primary sealing structure to cover the primary headspace (23). Once the beverage has cooled down, a vacuum builds up under the primary seal in the primary headspace (23) and the container distorts. Once cooled down, the side wall (9) of the primary sealing cap structure is screwed down from the “out” position (11), FIG. 3b, to the” in “position (12), shown in FIG. 3d, thereby displacing the headspace vacuum and distortion as the lower end (10) displaces the headspace downwardly, see FIGS. 3c-d. Mechanical compression can therefore achieve a positive pressure to enable the container to be refrigerated without paneling. It will be appreciated that many different structures are envisaged for providing a primary sealing structure that is forcible downwards to displace the liquid contents to a large degree. Containers of the 600 ml size for example will require displacement to the order of 30 cc of liquid. Containers of the 2000 ml range of size will require displacement to the order of 70 cc of liquid. The method of the present invention allows many variables in mechanical compression to be accounted for.

It is envisaged that the cap (8) may be of metal or plastics and could in alternative embodiments be pushed into the neck of the container (1) rather than screwed and could be lockable in a required position.

FIGS. 5a and 5b show the operation of a compressible cap (8) in separate detail. The seal (8) may be controllably displaced downwardly by any suitable mechanical or electrical or other means, or manually.

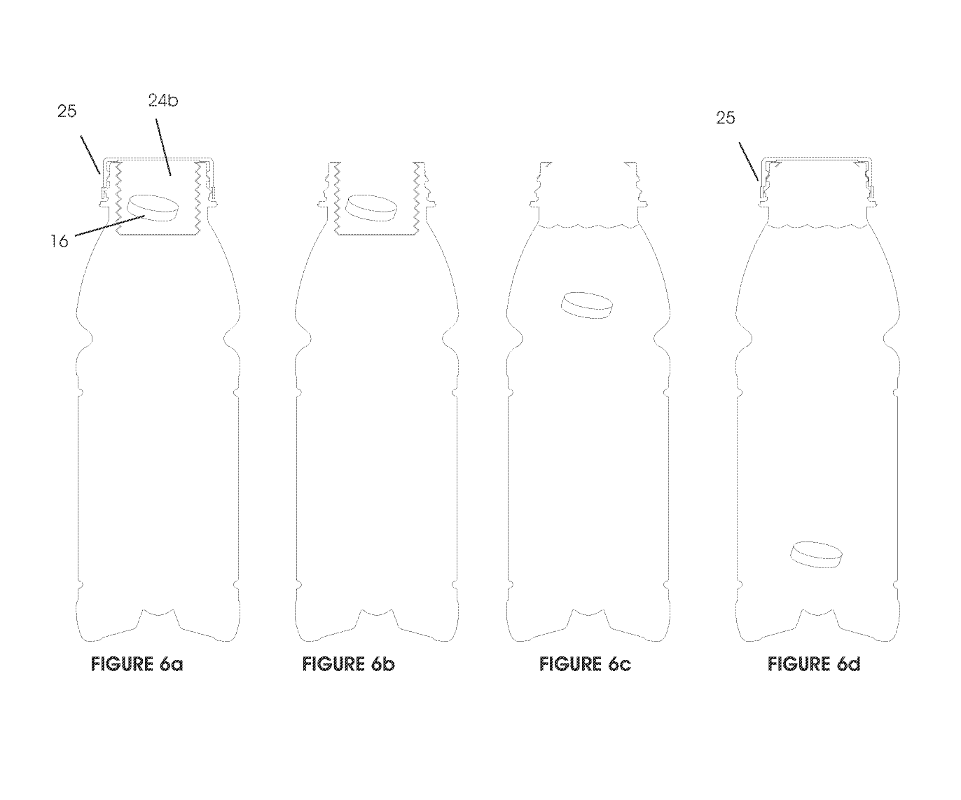

According to a further aspect of the present invention, and referring to FIGS. 6a-d, the secondary headspace (24b) between the primary and secondary seals may be utilized for placing commodities. Many commodities are envisaged, from simple promotional materials to products such as a tablet or pill that may be placed into the beverage after the cap is removed. A consumer may retrieve a commodity (16) from under the cap (25), remove the primary seal (4) and place the commodity (16) in to the beverage for example. By replacing the cap (25) and shaking the contents the commodity may mix with the beverage.

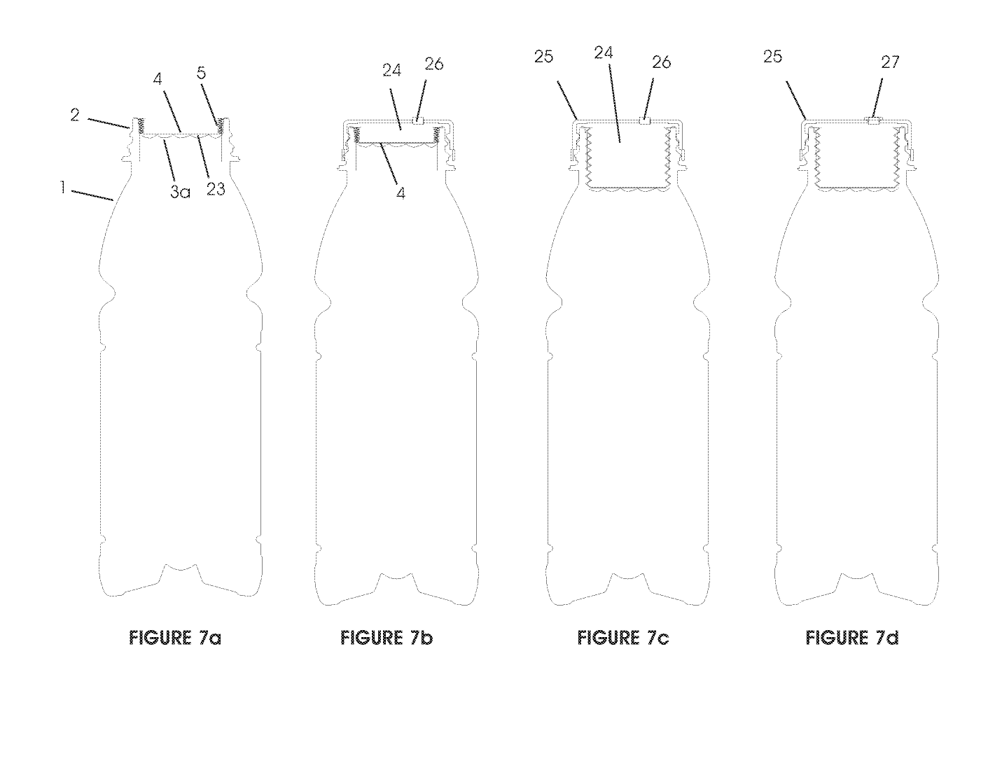

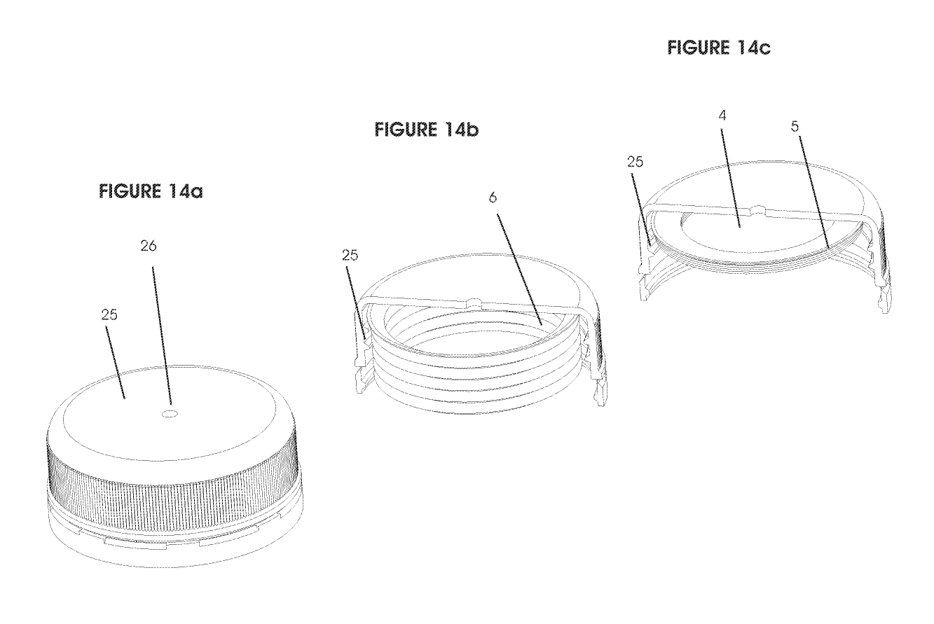

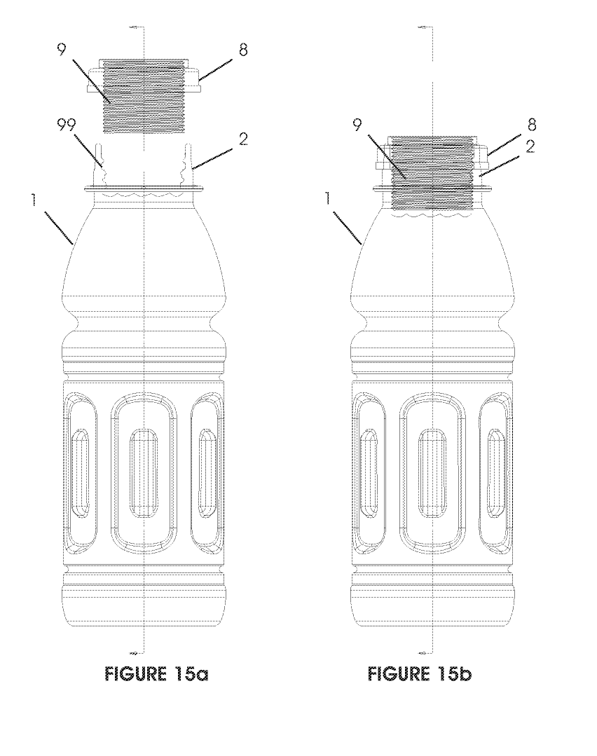

According to yet a further aspect of the present invention, and referring to FIGS. 7a-d and FIGS. 14 a-c, an aperture or port (26) may be contained within the secondary seal (25) such that as the product cools the primary seal (4) may expand downwardly and keep a pressure equilibrium within the container (1). A vacuum will not build in the secondary headspace (24) between the primary seal (4) and the secondary seal (25) due to the hole (26) allowing for ingress of outside air. The outside air is prevented from contacting the liquid due to the primary seal (4). As the secondary headspace (24) does not build a vacuum, then the outside pressure is able to force the primary seal (4) downwardly, such that a vacuum does not build in the primary headspace (23) either. Once the product has cooled down sufficiently, a further protective seal (27) may be applied to cover the hole (26) such that tampering with the container is prevented, and further ingress of air or objects does not occur.

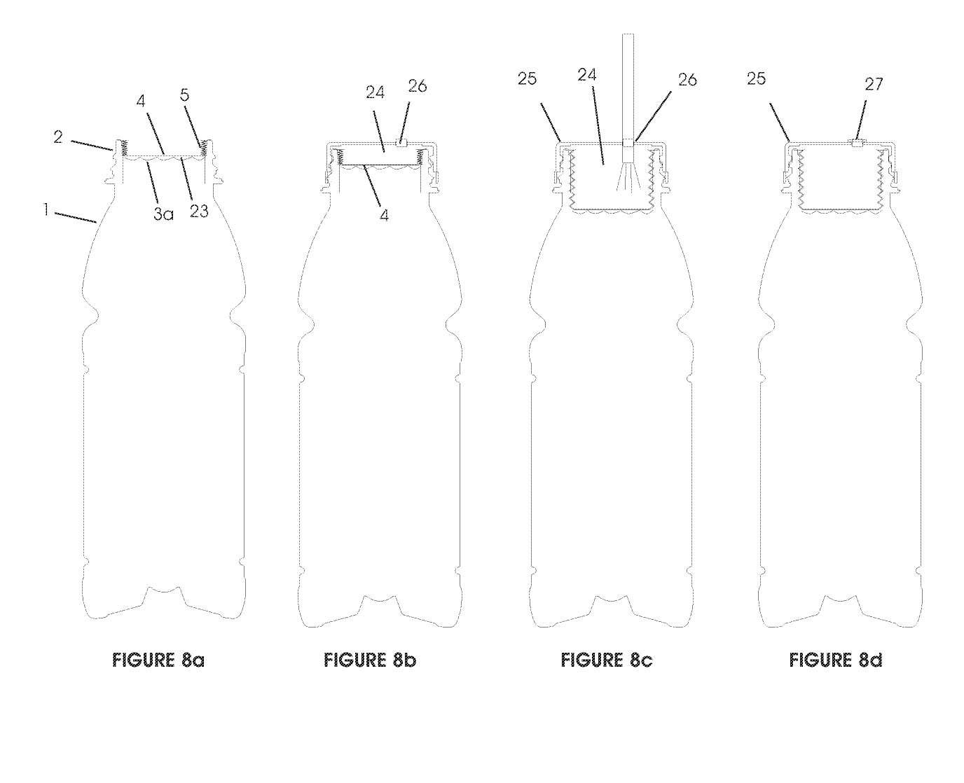

According to yet a further aspect of the present invention, and referring to FIGS. 8a-d, the secondary headspace (24) may be filled with a commodity to provide further beneficial effect. For example, a small amount of liquid nitrogen may be introduced by pressure injection (26) immediately prior to sealing (27). This would have the beneficial effect of pressurising the container (1) somewhat. Pressurizing containers by injecting small amounts of liquid nitrogen is commonplace for cold-fill beverages in order to create increased top load benefit. Great difficulty is experienced applying this process to hot-filled beverages, as normally the liquid nitrogen must be introduced while the beverage is hot. This creates enormous difficulties due to the hot temperatures of both the plastic container and the beverage. With the present invention, the nitrogen may be introduced when the product has cooled. In fact, any gas may be introduced under pressure for the same purpose, as the primary seal (4) prevents contact with the liquid occurring.

According to still a further aspect of the present invention, and still referring to FIGS. 8a-d, the commodity introduced by injection (26), or by any other means, by way of example only, may be an oxygen-scavenging agent. By introducing such a material, whether in gaseous or other form, at the time of processing the beverage, and containing it under the cap (25), the commodity may beneficially affect the contained liquid and prolong shelf life and flavour of the beverage over an extended timeframe. Choosing suitable materials for the primary seal (4), whereby the agent may favourably react with the product, will further enhance this.

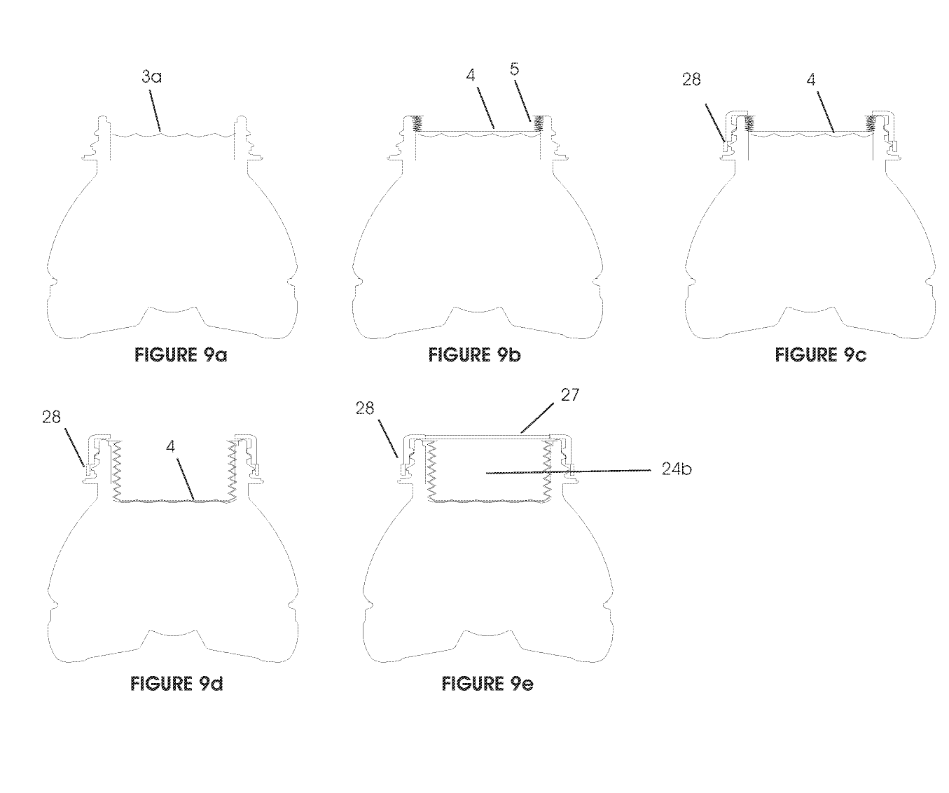

According to a further aspect of the present invention, the secondary sealing structure may have a largely absent centre, the equivalent of an extremely large ‘hole’ as shown in FIGS. 9 a-e. It will be further appreciated that the container may be any suitable shape or size, and in this example is shown as a ‘wide mouth’ jar or pot. After allowing for the primary seal (4) to expand and remove vacuum pressure, a sealing structure (37) may be screwed or otherwise put in to place on the secondary sealing cap (28) to provide suitable protection for the secondary headspace (24b). It will be appreciated that the sealing member (37) may be screwed in place at the time of applying the secondary sealing cap (28). This would result in a vacuum building up in the secondary headspace (24b) as the product cools. The sealing member (37) could then be unscrewed and replaced in position to allow for removal of vacuum pressure from the secondary headspace.

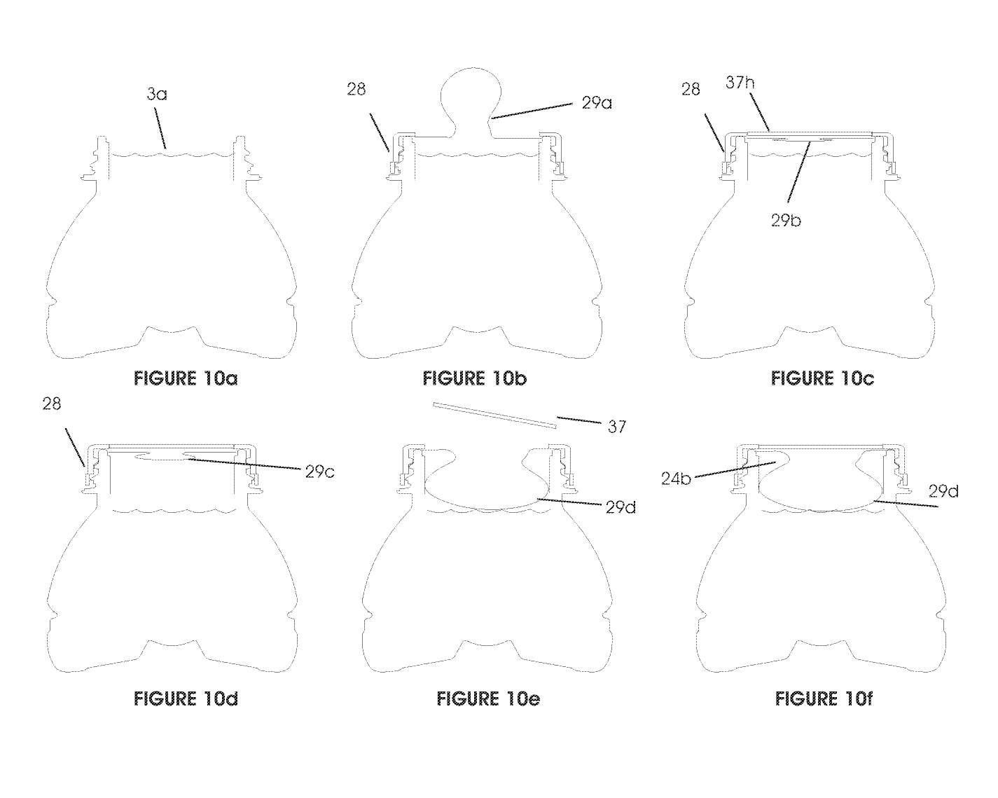

Referring to FIGS. 10 a-f, it will be appreciated that a highly flexible “balloon-like” structure for the primary seal (29a) could be utilised, and could be placed in an upright position when sealing the liquid. Once the sealing member (37) of the cap (28) is positioned, the primary seal (29b) will be compressed easily. Alternatively, the primary sealing balloon (29) could be placed downwardly facing. Once the liquid has cooled and a vacuum built up the primary seal (29c) may be expanded slightly due to the negative pressure inside the balloon, but after the sealing member (37) is removed to allow pressure equalisation and then replaced, the primary seal (29d) will immediately take a fully expanded position, removing all vacuum pressure.

In facilitating the present invention, the complete or substantial removal of vacuum pressure by displacing the headspace after the liquid has contracted, now results in being able to remove a substantial amount of weight from the sidewalls due to the removal of mechanically distorting forces.

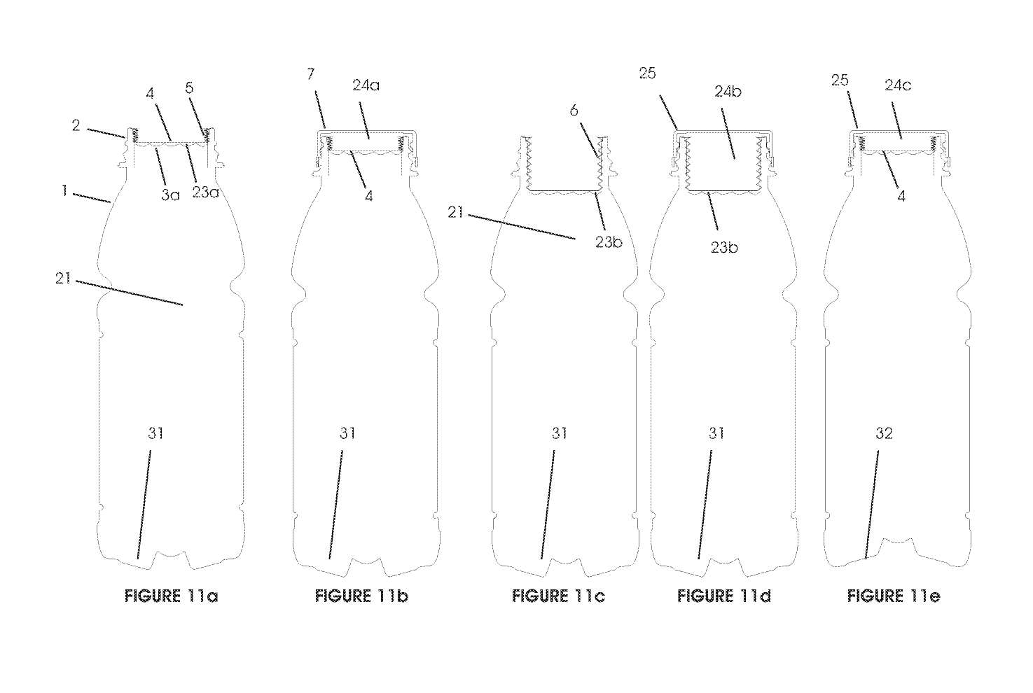

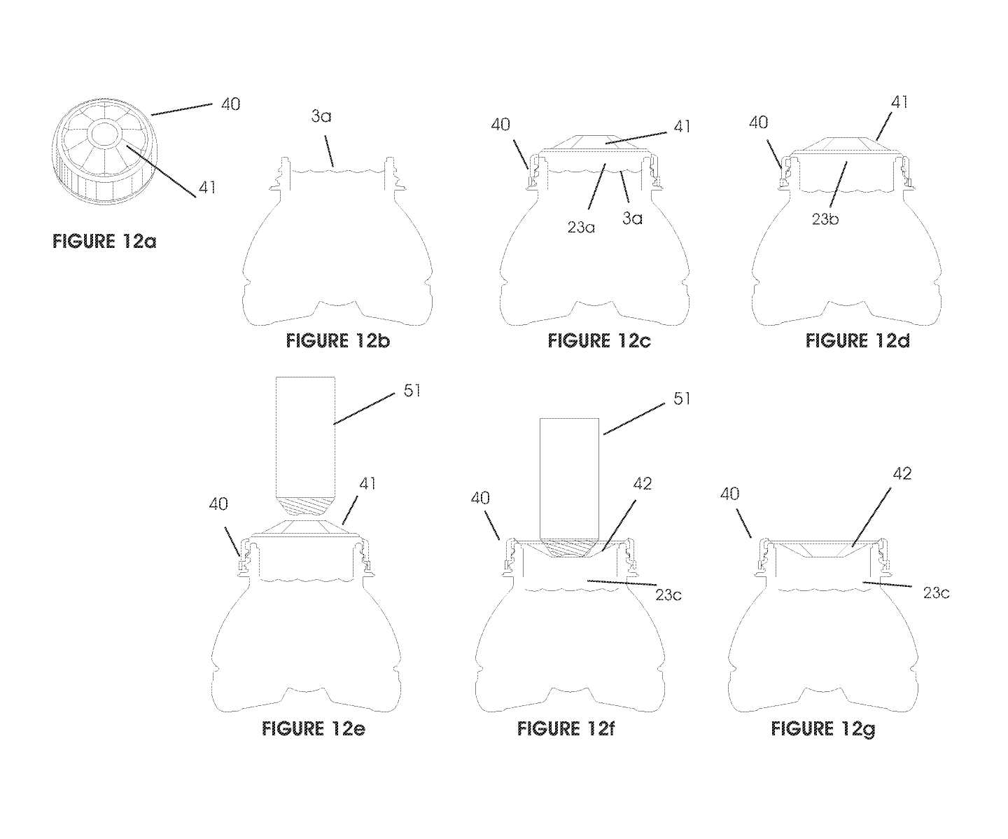

Referring to FIGS. 11 a-e, according to a further aspect of the present invention, a heated liquid may be filled in to the container and a primary sealing structure (4) applied. Referring to FIG. 11b, a secondary seal (7) may be applied in the form of a cap which may be temporary or permanent, such that the secondary headspace (24a) initially experiences a build up of pressure from the heated liquid but will then lower in pressure as the product cools and begin to build a vacuum pressure. Once cooling has finished the secondary seal (7) may be removed and replaced, for example, allowing the pressure to equalise in both the secondary headspace (24b), and the primary headspace (23b), such that there is no longer vacuum pressure. Following this procedure, the secondary headspace (24b) now separated from the liquid, being above the primary seal (4), may be compressed by inverting a transverse base panel 31 against the capped container at this time. Once the transverse base panel is inverted, (32), this results in the secondary headspace (24c) gaining in positive internal pressure to negate the effects of refrigeration on the sidewalls that would otherwise cause them to ‘panel’.

Referring to FIGS. 12a-g, according to a further aspect of the present invention the same result may be achieved by providing the primary sealing structure (40) with a transverse panel (41) that locks down after being forcibly inverted. The primary seal (40) in this instance may also become the permanent cap, although a secondary seal may also be applied over the primary seal to afford further protection or to incorporate commodities between the primary and secondary seal. The primary headspace (23a) may be quite large in this instance, being above the level of the liquid (3a) filled in to the container and below the level of the primary seal. Immediately following the application of the primary seal (40), pressure may build within the primary headspace (23a), but following cooling of the liquid a vacuum will ultimately build within the primary headspace (23b) as the level of the liquid drops upon product contraction, see FIG. 12d. In this particular embodiment, the primary seal may not be downwardly moveable under vacuum pressure alone, but may instead be forced downwardly under an applied mechanical force, such as by a mechanical rod (51) or punch or the like. As the mechanical rod is forced against the primary seal (40), the outwardly inclined transverse panel is forced in to an inverted position (42), see FIG. 12c, such that the primary headspace (23c) may be compressed to provide for removal of vacuum pressure within the container.

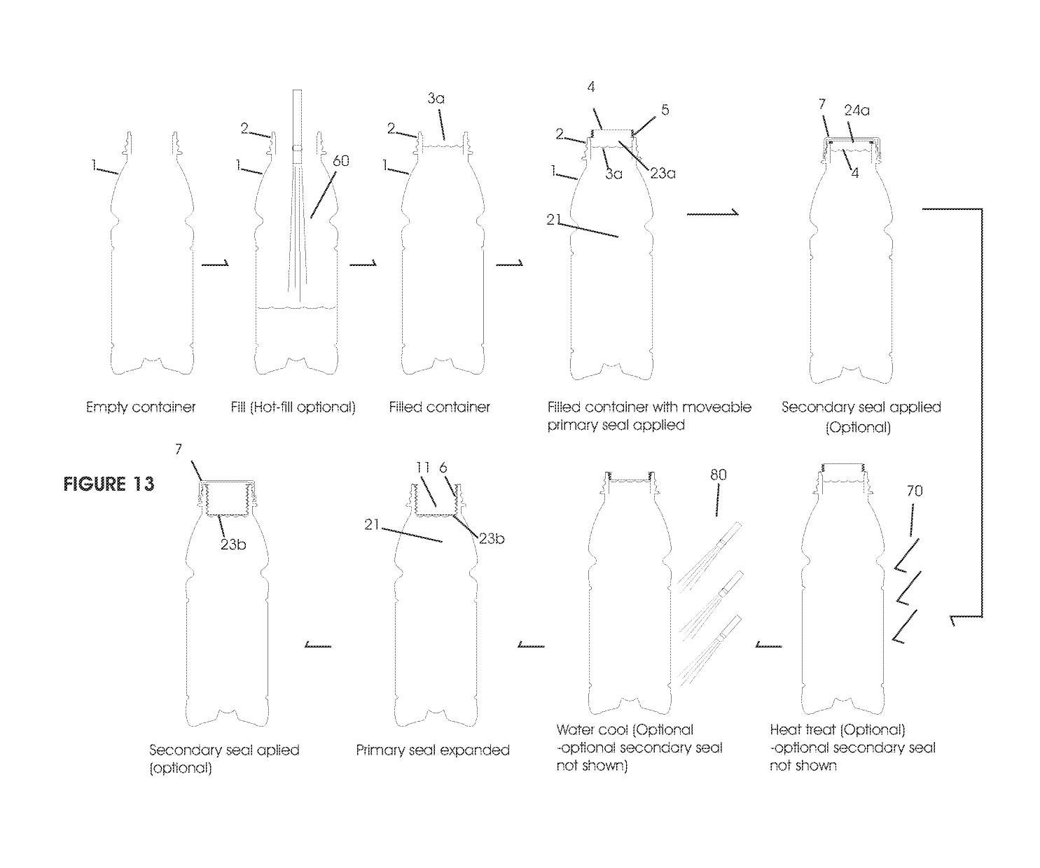

Referring now to FIG. 13, a preferred method for sealing and displacing the headspace in a container is illustrated. The pictorial schematic view of the method of the present invention includes optional features. The method begins by preparing an empty container (1). The container may or may not contain a transverse base panel (not shown). The next step is container filling (60), whereby the container is filled by a filling machine (not shown). The filled container is left with a filled level (3a). A primary seal (4) is applied to encapsulate the primary headspace (23a). If the liquid is optionally introduced hot then the inside of the container and the underside of the primary seal is sterilized by the heat. To assist this, the container may be typically turned upside down (not shown). If the liquid (21) is introduced cold instead and then optionally heated (70), sterilization takes place once a suitable temperature has been achieved. The container may be optionally cooled by a water spray (80) for example, or may be left to cool down. Once the liquid has cooled and contracted the primary moveable seal (40) may move downward to its position (6) to remove any vacuum within the container. If a secondary sealing structure (7) has been applied over the primary structure, then a passageway for outside air must be provided. This may be simply provided by removal and replacement of the secondary seal, or by provision of a hole or break in the secondary seal. The final step in the method encompasses the optional application of a closure, which may in fact be the secondary sealing structure (7). The container may then exit for storage and delivery. Optional steps may also include the introduction of a commodity, for example an oxygen scavenger, or liquid nitrogen, to the secondary headspace between the primary and secondary seals prior to final application of the secondary sealing closure.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1-22. (canceled)

23. A container having an upper portion with an opening into said container and a base, said upper portion having a neck finish which includes an expandable and moveable seal, wherein the seal is configured to be expandable and moveable relative to the container when sealed thereto and when a heated liquid is in the container, said seal moving downwardly towards the base and within the neck finish to compensate for vacuum forces during cooling of the liquid following sealing of the container, wherein said seal, to enable its downward movement, is selected from either of a flexible material having an expandable side wall, or a flexible balloon structure which is able to expand within the neck finish.

24. A container as claimed in claim 23 wherein a surface of said seal extends transversely across the neck finish and moves further into the neck finish as the seal expands.

25. A container as claimed in claim 23 or claim 24 wherein said seal is of said flexible material having an expandable side wall.

26. A container as claimed in claim 25 in which said side wall has a concertina construction providing for its expansion.

27. A container as claimed in claim 23 in which the seal includes a rim portion which can engage with a rim of the neck finish.

28. A container as claimed in claim 23 wherein said seal is of said flexible material having said expandable side wall and said seal provides a primary seal for the container, a secondary seal being provided for said neck finish over said opening into said container to define a secondary headspace between the primary and secondary seals.

29. A container as claimed in claim 28 in which a commodity is positioned within said secondary headspace.

30. A container as claimed in claim 29 in which said commodity is one of a tablet and a pill intended for mixing with the liquid before use.

31. A container as claimed in claim 28 in which said secondary seal includes one of an aperture and a port to provide access into said secondary headspace.

32. A container as claimed in claim 31 in which one of said aperture and said port allows ingress of outside air into said secondary headspace and closes off following sufficient cooling of the liquid.

33. A container as claimed in claim 31 in which one of said aperture and said port enables the entry into the secondary headspace of a commodity.

34. A container as claimed in claim 33 in which the commodity is an oxygen-scavenging agent.

35. A container as claimed in claim 23 in which the seal is of said flexible balloon structure which expands within the neck finish in compensating for vacuum pressure as the liquid cools.

36. A container as claimed in claim 23 wherein said base inverts to provide a compression of the seal to move it within the neck finish towards the said opening and to pressurize a secondary headspace above said seal.

37. A method of filling a container having a base and neck finish with a fluid which method includes introducing the fluid through an open end of the container so that it, at least substantially, fills the container, heating the fluid at least one of before and after its introduction into the container providing an expandable and moveable seal for the open end to cover and contain the fluid, said seal responding to the contraction of the fluid so as to compensate for pressure in a headspace of the container under the seal following sealing of the container, by moving downwardly towards the base and within the neck finish, wherein said seal, to enable its downward movement, is selected from either of a flexible material having an expandable side wall or a flexible balloon structure which is able to expand within the neck finish.

38. A method of filling a container as claimed in claim 37 in which said expandable side wall has a concertina construction.
